(19) United States
(12) Patent Application Publication
(10) Pub. No.: US 2024/0381884 A1
(43) Pub. Date: Nov. 21, 2024

(54) COOKING DEVICE

(71) Applicant: LIFETIME PRODUCTS, INC., CLEARFIELD, UT (US)

(72) Inventors: Lynn D VanDyke, Layton, UT (US); Donald Waite, North Ogden, UT (US)

(73) Assignee: LIFETIME PRODUCTS, INC., CLEARFIELD, UT (US)

(21) Appl. No.: 18/667,816

(22) Filed: May 17, 2024

Related U.S. Application Data
(60) Provisional application No. 63/503,456, filed on May 19, 2023.

(51) Int. Cl. A23B 4/052; A47J 37/07; F24C 3/08; F24C 11/00

(52) U.S. Cl. CPC A23B 4/052; A47J 37/0713; F24C 3/085; F24C 11/00

(57) ABSTRACT

A cooking device may include a cooking chamber with a first gas-powered heat source, such as a gas grill, disposed in the cooking chamber. The cooking chamber may also include a receptacle, such as a drawer, that is sized and configured to receive a solid fuel, which may be used to generate smoke. The drawer movable between a closed position in which the drawer and solid fuel are disposed inside the cooking chamber and an open position in which the drawer is at least partially removed from the cooking chamber. A second or secondary gas-powered heat source may reheat, reburn, and/or recombust the smoke from the solid fuel heat source to create smoke with different characteristics. The second gas-powered heat source and at least a portion of the drawer may be disposed in a vertically stacked configuration.

### CROSS-REFERENCE TO RELATED APPLICATIONS

The present application claims priority to and the benefit of U.S. Provisional Patent Application Ser. No. 63/503,456, entitled COOKING DEVICE, which was filed on May 19, 2023, which is incorporated by reference in its entirety.

### BACKGROUND

### Field

This disclosure generally relates to methods and/or devices for cooking foodstuffs and, more particularly, to methods and/or devices for cooking foodstuffs by grilling and/or smoking, and/or adding smoke flavoring to foodstuffs.

### Description of Related Art

Outdoor appliances have been used to cook food and these outdoor appliances, such as barbeque grills, are often used to cook meats, vegetables, and other types of food. A barbeque grill typically cooks food by applying heat directly to foodstuffs placed on a grill. Many barbeque grills use a gas as fuel, and propane or natural gas is typically used as a fuel source.

Many conventional gas-powered barbeque grills have an ignition button that, when pressed, generates a spark near a gas outlet on a burner. The spark ignites the gas, and the burner begins to create heat by burning the gas. The amount of heat is generally controlled using a dial or knob that controls the amount of gas supplied to the burner. In some cases, the barbeque grill may have electronic controls. Thus, instead of having a manual dial to adjust the amount of gas being introduced at the burner, an electronic control is set or adjusted by the user. The electronic control then interacts with a solenoid or other electro-mechanical component to regulate the flow of gas to the burner.

Wood pellet-burning grills are also popular for outdoor cooking. Conventional wood pellet-burning grills often employ a motor-driven auger to feed wood pellets into a combustion area, which may be referred to as a burn pot, where the pellets are burned to provide heat and smoke to cook the food products. Wood pellet-burning grills may be used for cooking food at relatively low temperature over an extended period. Wood pellet-burning grills, which may be referred to as smokers, may provide a particular taste imparted to the food products because of the smoke.

Wood pellet-burning grills may be operated by manual controls in which the user controls the number of pellets provided to the combustion area. Wood pellet-burning grills may also use an electronic temperature control system that is set by a user. Known wood pellet-burning grills often provide uneven smoke generation, and many known wood pellet-burning grills do not maintain a constant temperature within the cooking area. In addition, known wood pellet-burning grills often consume significant quantities pellets to generate heat and/or smoke, and many known wood pellet-burning grills include a large number of parts and components such as hoppers, augers, and the like.

The subject matter claimed herein is not limited to embodiments that solve any disadvantages or that operate only in environments such as those described. Rather, this background is only provided to illustrate one example area where outdoor appliances may be used.

### BRIEF SUMMARY

A need exists for a cooking device, and the cooking device may eliminate or diminish one or more of the above-described disadvantages and problems. The cooking device may provide one or more benefits and/or advantages, such as described below.

One aspect is a cooking device that may allow grilling and/or smoking of foodstuffs in the single cooking chamber. That is, foodstuffs may be cooked and/or smoked in the same cooking chamber, and the foodstuff does not have to be moved to another chamber or location for cooking and/or smoking. In an example embodiment, the foodstuffs may be grilled by a gas-powered heat source, such as a gas-powered grill, and the same foodstuffs may be smoked and/or smoke flavor may be added by burning or combusting a combustible fuel. The combustible fuel may be a solid fuel, such as pelletized fuel, and the pelletized fuel may be pellets or wood pellets.

Another aspect is a cooking device that may include a single cooking chamber and the single cooking chamber may be at least partially formed by single structure. In an example embodiment, the single cooking chamber may be at least partially formed by an integral, one-piece structure. The single cooking chamber may include one or more access portions, such as drawers and/or openings, which may provide access to an interior portion of the single cooking chamber. The single cooking chamber may also include other access portions such as a lid, cover, closure, and the like.

Still another aspect is a cooking device that may include a single cooking chamber with two or more heat sources. A first heat source may be a gas-powered heat source, such as a gas-powered grill, and a second heat source may be a solid fuel heat source, such as pelletized fuel. The first and second heat sources may be used independently and/or concurrently. The first and second heat sources may be used for similar purposes and/or functions, such as providing heat to the cooking chamber. The first and second heat sources may also be used for different purposes and/or functions, such as one heat source primarily providing heat to the cooking chamber and another heat source primarily providing smoke to the cooking chamber. For example, the first heat source may be a gas-powered grill and the gas-powered grill may be intended to primarily heat and/or cook foodstuffs in the cooking chamber. The second heat source may combust fuel, such as a solid fuel, and the second heat source may be sized and configured to primarily generate smoke. For instance, the second heat source may allow pelletized fuel, such as wood pellets, to burn and/or smolder to generate smoke. The smoke may be generated from the relatively inefficient burning of the fuel, and the smoke may be generated to add flavoring, taste, and/or seasoning to the foodstuffs. The cooking device may include additional heat sources, such as a third heat source. The third heat source may be a gas-powered heat source, such as a gas burner. The third heat source may have features, functions, and/or purposes as the first or second heat source. The third heat source may also have other functions, such as reheating, reburning, and/or recombusting the smoke from the second heat course.

Yet another aspect is a cooking device that may include a cooking chamber with a heat source, which may be primarily intended to heat and/or cook foodstuffs, and a flavoring source, which may be primarily intended to add flavoring, taste, and/or seasoning to the foodstuffs. The heat source may be a gas-powered heat source, such as a gas-powered grill, and the flavoring source may be intended to add flavoring to the foodstuffs, such as smoke flavoring. In an example embodiment, the flavoring source may be intended to generate smoke, such as by smoldering and/or burning a solid fuel, such as pelletized fuel. The flavoring source may also be intended to generate substantial amounts of smoke. For example, the flavoring source may be sized and configured to generate smoke rather than heat. The flavoring source may also be sized and configured to allow the fuel to be combusted very slowly, which may significantly reduce the amount of fuel needed during use, and the fuel may be intentionally combusted in a manner to facilitate generation of smoke.

Still yet another aspect is a cooking device that may include a cooking chamber with a primary heat source and a secondary heat source. In an example embodiment, the primary heat source may be primarily intended to heat and/or cook foodstuffs in the cooking chamber, and the secondary heat source may be a flavoring source that is primarily intended to provide flavoring, taste, and/or seasoning to the foodstuffs in the cooking chamber. For example, the first heat source may be sized and configured to provide a significant amount of heat and/or energy to the cooking chamber, such as a gas-powered grill, and the second heat source may be sized and configured to provide a smaller amount of heat and/or energy to the cooking chamber. In this example embodiment, the first heat source may be sized and configured to more quickly cook and/or heat foodstuffs, while the second heat source may be sized and configured to more slowly cook and/or heat foodstuffs. Additionally, or alternatively, the second heat source may be intended to provide flavoring to the foodstuffs, such as by generating smoke. That is, in one example embodiment, the second heat source may be primarily intended to generate smoke to flavor foodstuffs and the first heat source may be primarily intended to heat and/or cook foodstuffs.

A further aspect is a cooking device that may allow a particular taste or attribute, such as a smoke flavoring, to be introduced or added. The taste or attribute may be added before, during, and/or after the cooking process. In an example embodiment, the cooking device may include a gas-powered heat source, such as a gas-powered grill, and the gas-powered grill may be used for cooking foodstuffs in a cooking chamber. The example cooking device may also include a structure, such as a receptacle or drawer, which is sized and configured to allow combustion of a fuel such as pelletized fuel. The pelletized fuel, which may be wood pellets, may burn and/or smolder to create smoke, which may be used to flavor the foodstuffs. The cooking device may be sized and configured to allow the pellets to burn slowly and/or smolder, which may allow a desired amount of smoke to be created, and the cooking device may consume a relatively small number of pellets, which may decrease costs. In an example embodiment, the structure may be sized and configured to allow the pellets to burn and/or smolder slowly, which may allow a small number of pellets to be used, which may significantly decrease costs. Additionally, because only a small number of pellets may be used, large or bulky pellet containers and pellet delivery systems, such as an auger, may not be needed. Therefore, the cooking device may be easier to manufacture and assemble because it may include considerably fewer parts and components than convention cooking appliances. Moreover, all the pellets may be disposed inside the cooking chamber during the cooking process. Thus, there may be no external storage or placement of the pellets outside the cooking chamber.

A still further aspect is a cooking device that may generate smoke, and the cooking device may reheat, reburn, and/or recombust the smoke. In an example embodiment, the cooking device may generate smoke by burning one or more types of fuel, such as pelletized fuel. The pelletized fuel may slowly burn, combust, and/or smolder to create smoke. The smoke may be reheated, reburned, and/or recombusted by, for example, a heat source such as a gas-powered heat source. The gas-powered heat source, such as a gas burner, may reheat the smoke. For example, the gas-powered heat source may heat the smoke to a higher temperature, may reburn the smoke, and/or recombust the smoke. For instance, the smoke may include portions or particles that are not completely or fully burned, and the gas-powered heat source may reburn or more fully burn at least a portion of the smoke. The gas-powered heat source may recombust at least a portion of the smoke. For example, the originally generated smoke may include portions or particles that are not completely or fully combusted, and the gas-powered heat source may recombust or more fully combust at least a portion of the smoke. In an example embodiment, the cooking device may include a structure, such as a drawer, and the drawer may be sized and configured to allow combustion of a fuel such as pelletized fuel. The cooking device may allow the pellets to burn and/or smolder to generate smoke, and the burning and/or smoldering of the pellets may occur at a first temperature. The smoke may be reheated, reburned, and/or recombusted, and the reheating, reburning, and/or recombusting of the smoke may occur at a second temperature, which may be higher than the first temperature. The reheating, reburning, and/or recombusting of the smoke may occur by allowing the smoke to flow past a heat source such as a gas-powered burner. The burner may reheat, reburn, and/or recombust the smoke, and the smoke may be used to flavor and/or impart a taste to the foodstuffs. Advantageously, the reheated, reburned, and/or recombusted smoke may significantly improve the taste and/or quality of the foodstuffs. Thus, the originally generated smoke may have a first set of characteristics and the reheated, reburned, and/or recombusted smoke may have a second set of characteristics, which may be different from the first set of characteristics. The different characteristics may allow the smoke to add different flavoring, taste, and/or seasoning to foodstuffs in the cooking device.

Yet another further aspect is a cooking device that may add smoke flavoring, taste, and/or seasoning without requiring consumption of a large amount of fuel, such as a substantial number of wood pellets. For example, convention smokers include a large hopper that is filled with pellets and an auger or other type of system is typically used to feed pellets to the combustion area. A general rule of thumb for conventional smokers is that about two (2) pounds of pellets are consumed for every hour of low temperature cooking and slow smoking, or about four (4) pounds of pellets are consumed for every hour of higher temperature cooking. Because conventional smokers are often used for several or many hours at a time, many known smokers include hoppers that hold twenty (20) or more pounds of pellets. This allows convention smokers to be used for extended periods. Loading pellets into the hopper may be difficult because it often involves lifting bags of pellets, which often weight forty (40) pounds, above the hopper and pouring the pellets into the hopper. In addition, because it can be hard to load pellets into the hopper, some conventional smokers include oversized hoppers to reduce the frequency in which pellets need to be added to the hopper. In contrast, the cooking device of the present disclosure may only consume about one (1) or about two (2) cups of pellets during a typical cooking cycle, and the cooking device may consume generally the same or similar number of pellets when cooking at lower and higher temperatures. Thus, the cooking device may use considerably less pellets than a conventional smoker, and that may decrease costs. In addition, the cooking device may require fewer pellets to be stored, transported, purchased, and the like because fewer pellets may be consumed during the cooking process. The pellets may also be much easier and/or quicker to load into the cooking device because only one or two cups of pellets may be used during the cooking process rather than multiple pounds of pellets that are required with conventional smokers.

Still yet another further aspect is a cooking device that may include a structure, such as a receptacle or drawer, and the drawer may be filled with pellets, and the pellets may burn and/or smolder within the cooking chamber. For example, the pellets may burn and/or smolder within the cooking camber to create smoke, The drawer may be at least substantially disposed within the cooking device during use, and the drawer may be removable from the cooking device for filling with pellets, cleaning, and the like. The drawer, however, does not need to be removable and the drawer may be disposed in a fixed position. Advantageously, all the pellets used during a cooking process may be disposed in the drawer and an external supply of pellets, such as from a hopper, may not be needed. Additionally, all the pellets may be disposed within the cooking chamber during the cooking process and pellets may not need to be added during the cooking process, which may eliminate the need for pellet storage devices and pellet supply systems. In an example embodiment, a thin layer of pellets may be disposed in the drawer and an ignitor or other suitable source may be used to ignite the pellets. The pellets may slowly burn and/or smolder within the drawer and, because all the pellets may be contained within the drawer, the pellets may be easily loaded. In an example embodiment, the drawer may be positioned proximate a heat source, such as a gas-powered burner, and the burner may reheat, reburn, and/or recombust the smoke generated from the pellets. For example, at least a portion of the drawer may be disposed below the burner in a vertically stacked configuration. This may allow the smoke generated by burning and/or smoldering of the pellets to be reheated, reburned, and/or recombusted by the gas-powered burner.

Another aspect is a cooking device that may include a cooking chamber. The cooking chamber may be disposed within a housing, and the housing may support the cooking chamber above a surface, such as a floor. A cooking structure may be at least partially disposed in the cooking chamber, and the cooking structure may include one or more cooking surfaces. The cooking device may include a first heat source and a second heat source. The first heat source may be a gas-powered heat source such as a gas grill. The second heat source may comprise a solid fuel heat source, and the second heat source may combust a solid fuel such as pelletized fuel. The pellets may contain wood or other combustible materials, and the wording “pellets” and “wood pellets” may refer to any type of pellets and/or pelletized fuel, even if the pellets do not actually contain wood.

Still another aspect is a cooking device that may include a single cooking chamber with one or more heat sources. The cooking chamber may include one or more cooking structures and one or more cooking surfaces, and the cooking structures and/or cooking surfaces may be sized and configured for placement of foodstuffs. In an example embodiment, a heat source may be sized and configured to provide heat to the cooking chamber, such as a gas-powered heat source, e.g., a gas grill, and another heat source may be sized and configured to provide heat and/or smoke to the cooking chamber by burning or combusting a fuel, such as pelletized fuel. In an example configuration, one or both heat sources may provide heat directly to the foodstuffs. For example, if the cooking structure or surface is a grill or grate, heat from one or both heat sources may directly heat at least a portion of the foodstuffs disposed on the cooking structure or surface. The heat sources may be usable independently and/or concurrently, and the heat sources may be controlled independently or simultaneously. This may allow the single cooking chamber to be heated by one or both heat sources, and the heat sources may be used on its own or in combination. The heat sources may be sized and configured to burn different types of fuel. For example, one heat source may be configured to combust a first type of fuel and another heat source may be configured to combust a second type of fuel, and the types of fuel may be different. The heat sources may also be used for different purposes. In an example embodiment, one heat source may be primarily used for heating and/or cooking the foodstuffs. The other heat source may be primarily used for generating smoke, and the smoke may be reheated, reburned, and/or recombusted. For instance, the smoke may be reheated, reburned, and/or recombusted by a third heat source, such as a gas-powered burner. The third heat source may be part of the first heat source and/or the second heat source.

Advantageously, the cooking device may include two or more heat sources disposed in a structure, such as a cooking chamber or cooking volume, and the structure may be a single, integrated structure. This may allow the cooking device to cook foodstuffs by different methods, provide different types of heating (such as direct and indirect heating), use different types of fuels, burn fuels for different reasons (e.g., for generation of heat and/or generation of smoke), and/or a combination thereof. For example, the same cooking chamber may be used for grilling via a gas-powered grill and/or adding smoke flavoring, taste, and/or seasoning by burning or combusting pelletized fuel. Thus, instead of using one structure or apparatus for grilling and a different structure or apparatus for smoking, the disclosed cooking device may allow the same cooking chamber to be used for grilling and/or adding smoke flavoring, taste, and/or seasoning to foodstuffs.

In an example embodiment, a heat source, such as the gas grill, may be used for grilling, and another heat source may be used for smoking and/or adding a particular flavoring, taste, and/or seasoning to the foodstuffs, such as a flavoring, taste, and/or seasoning created at least in part by smoke from one or both heat sources. For example, the smoke may be primarily generated by a solid fuel heat source and that smoke may be used to add smoke flavoring, taste, and/or seasoning to the foodstuffs in the cooking chamber. The smoke generated by the solid fuel heat source may be at least partially reheated, reburned, and/or recombusted by another heat source, and the reheated, reburned, and/or recombusted smoke may be used to add smoke flavoring, taste, and/or seasoning to the foodstuffs in the cooking chamber. In this example configuration, a first heat source may be a gas grill and it may be primarily used for cooking foodstuffs in the cooking chamber, and a second heat source may primarily be used to provide flavoring or taste to the foodstuffs by the burning or combustion of fuel such as wood pellets. The wood pellets may be intentionally burned or combusted in a way to generate smoke. The wood pellets may also be intentionally allowed to smolder, burn inefficiently, burn slowly, etc., which may allow a considerable amount of smoke to be generated while consuming a limited number of pellets. A third heat source, such as a gas burner, may be used to reheat, reburn, and/or recombust smoke, such as smoke from the burning, combustion, and/or smoldering of the wood pellets.

Yet another aspect is a cooking device that may have distinct types of heating sources disposed in the same cooking chamber or volume. The cooking device may also include different heat sources for one or more different purposes. For example, the cooking device may include a cooking chamber with one or more gas-powered heat sources and a solid fuel heat source such as a wood pellet heat source. In an example embodiment, a first gas-powered heat source may be sized and configured to facilitate cooking foodstuffs, a solid fuel heat source may be sized and configured to facilitate generation of smoke, and a second gas-powered heat source may be sized and configured to reheat, reburn, and/or recombust the smoke from the solid fuel heat source. In this example embodiment, all three heat sources may be disposed in the same cooking chamber. In this example embodiment, the first gas-powered heat source may be sized, configured, and/or arranged to directly heat one or more cooking structures or cooking surfaces, and/or cook foodstuffs in the cooking chamber. The solid fuel heat source may be sized, configured, and/or arranged to generate smoke in the cooking chamber, and the smoke may be used to provide a particular flavor and/or taste to the foodstuffs. The second gas-powered heat source may be used to reheat, reburn, and/or recombust the smoke from the solid fuel heat source. Thus, in an example embodiment, a first heat source may be sized and configured to primarily cook foodstuffs in the cooking chamber, a second heat source may be sized and configured to primarily provide smoke to the cooking chamber, and a third heat source may be sized and configured to primarily reheat, reburn, and/or recombust the smoke. Additionally, or alternatively, the first and third heat sources may be the same, or part of the same same heat source. The first and third heat sources may be related heat sources.

In an example embodiment, the first heat source may be configured for cooking or heating foodstuffs at higher temperatures and/or for high heat cooking processes, such as grilling. The second heat source may be configured for providing smoke and/or a smaller amount of heat to the cooking chamber, and the second heat source may provide significantly less heat than the first heat source. The second heat source may, in some embodiments, not provide any or any significant amount of heat to the cooking chamber. Instead, the second heat source may at least primarily provide smoke. In an example embodiment, the second heat source may be sized, configured, and/or arranged to provide smoke to the cooking chamber and, if desired, the second heat source may not be intended to provide a significant amount of heat to the cooking chamber. Therefore, in this example embodiment, the second heat source may be intended to primarily provide smoke and the second heat source may provide only a limited amount of heat, if any, to the cooking chamber. The second heat source, however, could provide a larger amount of heat if desired. In this example embodiment, the first heat source may be intended to be more frequently used for cooking foodstuffs and the second heat source may be intended to be more frequently used for adding smoke to the cooking chamber. Thus, the cooking device may be sized, configured, and/or arranged to facilitate cooking operations by the first heat source, and the second heat source may be sized, configured, and/or arranged to provide smoke to the cooking chamber. A third heat source may be sized, configured, and/or arranged to reheat, reburn, and/or recombust smoke, such as smoke from the second heat source. The third heat source may also be sized, configured, and/or arranged to facilitate cooking operations. The cooking device may enable cooking operations that involve grilling, smoking, and/or providing smoke or smoke flavoring, and these operations may occur individually and/or concurrently. If desired, cooking operations may be controlled by a user, by one or more electronic or automatic controls or controllers, and/or by both the user and the controls or controllers.

Still yet another aspect is a cooking device that may include a first heat source that provides a particular heating function, such as the emission of a first thermal energy. The first thermal energy may be directly distributed across most, or at least substantially all, of the cooking structure and/or cooking surfaces. The first heat source may be a gas-powered grill that provides a large thermal output, which may allow foodstuffs to be warmed, heated, and/or cooked relatively quickly. The second heat source may provide a second thermal energy, and the second heat source may provide a low thermal output. The second heat source may be sized and configured to provide smoke and/or smoke flavoring to foodstuffs disposed in the cooking chamber. For example, the second heat source may combust solid fuels such as pelletized fuels, wood pellets, biomass, and the like, and the second heat source may combust the fuels in a manner to generate smoke. The third heat source may reheat, reburn, and/or recombust the smoke from the second heat source. In an example embodiment, the first heat source may have a high thermal output, may directly provide thermal energy to the cooking surface and/or cooking structure, may directly provide thermal energy to the foodstuffs, and/or may quickly heat, prepare, and/or cook the foodstuffs. The second heat source may have a low thermal output, and the second heat source may be sized, configured, and/or arranged to provide smoke. The third heat source may reheat, reburn, and/or recombust the smoke from the second heat source. Additionally, and/or alternatively, the third heat source may be used during the cooking process. For example, the first and third heat sources may be used in combination, and the first and third heat sources may be used to cook the foodstuffs. The first and third heat sources, however, do not have to be used to cook the foodstuffs. The second heat source may be used to provide smoke, and the second heat source may be used to cook the foodstuffs and/or provide a flavoring, taste, and/or seasoning to foodstuffs in the cooking chamber.

A further aspect is a cooking device that may generate smoke, which may be generated at a low temperature, and then the smoke may be reheated, reburned, and/or recombusted, which may be at a higher temperature. For example, smoke may be generated by slowly burning a fuel, such as a solid fuel, at a relatively low temperature. In an example embodiment, the fuel, which may be wood pellets or pelletized fuel, may smolder or burn relatively slowly and/or at a relatively low temperature to generate smoke. Advantageously, if the fuel slowly burns and/or smolders, the rate of fuel consumption may be quite limited, and this may allow the cooking device to use a small amount of fuel to generate smoke. Significantly, this may allow the cooking device to provide foodstuffs with the desired taste, but only a small amount of fuel may be required to generate the desired taste.

Another further aspect is a cooking device that may generate smoke by smoldering, slowly burning, and/or using a fuel source such as wood pellets to generate smoke. This smoke, in an example embodiment, may be generated at a relatively low temperature. The smoke may then be reheated, reburned, and/or recombusted by a heat source such as by a gas burner. The gas burner may heat the smoke to a higher temperature, and the gas burner may burn or combust materials at the higher temperature. In an example embodiment, the smoke may be generated at a first temperature, such as a lower temperature, and the smoke may be reheated, reburned, and/or recombusted at a higher temperature. The reheated, reburned, and/or recombusted smoke may provide improved flavoring, taste, and/or seasoning. In an example embodiment, the reheated, reburned, and/or recombusted smoke may provide improved flavoring and/or taste than smoke that has not been reheated, reburned, and/or recombusted.

A still further aspect is a cooking device that may generate smoke by combustion of a solid fuel, such as wood pellets, and the smoke may be reheated, reburned, and/or recombusted. In an example embodiment, smoke may be generated by burning and/or smoldering wood pellets in a container, such as a receptacle or drawer, and then the smoke may be reheated, reburned, and/or recombusted by a heat source. For example, the smoke may flow past a heat source, such as a gas burner, and the heat source may reheat, reburn, and/or recombust, the smoke, and the smoke may be heated to a higher temperature. The reheated, reburned, recombusted, and/or higher temperature smoke may then flow towards the cooking structures, cooking surfaces, and/or foodstuffs. Advantageously, the reheated, reburned, recombusted, and/or higher temperature smoke may provide increased flavoring, taste, and/or seasoning to the foodstuffs. Because the smoke may be generated at a lower temperature, the rate of fuel consumption may be significantly decreased. Thus, instead of the substantial number of pellets being required to create the desired taste in a conventional smoker, the disclosed cooking device may use a much smaller number of pellets because the pellets may be primarily used to generate smoke rather than as a heat source.

Advantageously, the cooking device may provide increased functionality and potential uses because a smaller amount of fuel, such as pellets, may be used to create the desired flavor and/or taste. For example, the cooking device may be used as a grill and smoke flavoring, taste, and/or seasoning may be selectively added when desired. In an example embodiment, the cooking device may allow foodstuffs to be grilled and/or smoke flavoring be added to foodstuffs, and the grilling and adding of smoke flavoring may occur separately, simultaneously, and/or in any desired combination. Thus, foodstuffs may have different tastes, flavoring, textures, seasoning, and the like depending, for example, on if the foodstuffs are grilled, smoked, and/or if smoke flavoring is added. In addition, the cooking device may be more easily used, operated, cleaned, etc. because less pellets may be used in comparison to a conventional wood pellet-burning system.

Another aspect is a cooking device that may include a single cooking chamber, and a cooking structure may be disposed within the cooking chamber. The cooking structure may include one or more cooking surfaces configured for placement of foodstuffs. A first heat source may be at least partially disposed within the cooking chamber, and the first heat source may include a gas-powered heat source with one or more burners disposed in the cooking chamber. A second heat source may be at least partially or at least substantially disposed within the cooking chamber, and the second heat source may include a compartment, container, receptacle, vessel, structure, or the like, such as a drawer, which may be disposed in the cooking chamber during use. The drawer may be sized and configured to allow a solid fuel, such as pellets, to burn and/or generate smoke. In an example embodiment, the cooking device may be sized, configured, and/or arranged so that the pellets may burn or smolder slowly. The cooking device may also be sized, configured, and/or arranged so that the pellets generate smoke, and the smoke may be directed or flow towards a heat source such as a burner, and the burner may reheat, reburn, recombust, and/or heat the smoke to a higher temperature. The drawer may be disposed below the burner, and the drawer and the burner may be at least partially disposed in a vertically stacked configuration. The drawer may be movable between an open position and a closed position relative to the cooking chamber. The drawer may be removable from the cooking device, which may facilitate cleaning of the drawer and/or the cooking device.

Still another aspect is a cooking device may include a drawer and the drawer may be removable from the cooking chamber. The drawer may be sized and configured to receive a solid fuel, such as pelletized fuel. The drawer may extend across or along a portion of the cooking chamber, and the drawer may be configured to extend from one side to the other side of the cooking chamber. For example, the drawer may extend from a front portion of the cooking chamber to a rear portion of the cooking chamber, or from one side to the other side of the cooking chamber. In an example embodiment, the drawer may be at least partially filled with pellets. For example, a relatively thin layer of pellets may fill all or a portion the drawer, such as an upper portion of the drawer. The drawer may include a divider, such as a screen or grate, and the pellets may be placed on the grate. The grate may dispose the pellets above a lower portion of the drawer, and the grate may facilitate airflow around the pellets. For example, the grate may allow air to flow underneath the pellets, and a fan or other device may be used to control (e.g., increase and/or decrease) airflow. In an example embodiment, an ignitor may be used to ignite the pellets. For instance, the ignitor may be used to ignite the pellets, and this may allow the pellets to burn or smolder. The airflow may be configured to facilitate burning of the pellets, generation of smoke, and/or control the flow of smoke. In an example embodiment, the ignitor may be placed towards an end or side of the drawer, such as a rear portion, and the cooking device may be sized and configured to facilitate burning of the pellets from one end of the drawer towards the other end of the drawer. Because the pellets are disposed in the drawer and the pellets are combusted in the drawer, no external source of pellets, such as a pellet hopper, may be needed. In addition, no augers or other structures may be needed because the pellets may be simply placed in the drawer and then the drawer may be inserted into the cooking device. Thus, in an example embodiment, all the pellets may be disposed in the cooking device and, if desired, all the pellets may be disposed in the cooking chamber. Because no external pellet source or pellet delivery system is required, the cooking device may be relatively straightforward to manufacture, assemble, and use.

Still yet another aspect is a cooking device that may include a drawer that may be filled with pellets, and the drawer may be at least substantially or entirely disposed in the cooking chamber when the drawer is disposed in the closed position. When the drawer is disposed in the cooking chamber, a portion of the drawer may be disposed at least proximate an ignitor and the ignitor may be used to ignite pellets disposed in the drawer. In an example embodiment, the ignitor may be at least partially disposed in the cooking chamber, and the ignitor may be disposed in a rear portion of the cooking chamber. The drawer may be disposed between the rear portion and a front portion of the cooking chamber, and the drawer may be sized and configured to allow the pellets to burn from one end of the drawer towards the other end of the drawer.

Still another aspect is a cooking device that may include a smoke distribution and/or air supply system. The smoke distribution system may at least partially control the flow of smoke within the cooking chamber. For example, the smoke distribution system may help control the flow of smoke towards a heat source where the smoke may be reheated, reburned, and/or recombusted. The smoke distribution system may also direct smoke towards the cooking structure, cooking surfaces, and/or the foodstuffs. The air supply system may include one or more passageways, openings, and the like to allow air to enter the cooking chamber. For example, the air supply system may allow air to flow towards a heat source or an area in which pelletized fuel is intended to be burned or combusted. In an example embodiment, a fan or other device may control air flowing towards the pelletized fuel. For instance, a fan may direct air towards a lower portion of a drawer and, if the pellets are disposed on a grate in the upper portion of the drawer, air may flow from the lower portion of the drawer to the upper portion of the drawer and towards the pellets. The drawer may include a lid and the lid may include one or more openings. For instance, one or more openings may be disposed towards the opposite end of the drawer from the ignitor. The one or more openings in the lid may be at least partially disposed below a heat source, such as a gas burner. This may allow, for example, smoke to flow out of the one or more openings and towards the heat source. The heat source may reheat, reburn, recombust, and/or heat the smoke to a higher temperature, and then the smoke may flow towards the cooking structure, cooking surfaces, and/or the foodstuffs.

A further aspect is a cooking device that may include a container, such as a receptacle or drawer, and the drawer may be at least partially disposed below a heat source, such as a burner. The drawer may be sized and configured to facilitate distribution of smoke towards the burner. The drawer may be sized and configured to be slidably disposed within an opening of the cooking chamber; the drawer may slide in and out of the opening in the cooking chamber when the drawer is moved between the open and closed positions; and the drawer may be removable from the cooking device. Additionally, or alternatively, the drawer may be disposed in a fixed position and the drawer does not have to be removable from the cooking chamber.

A still further aspect is a cooking device that may include a first heat source that is sized and configured to cook foodstuffs in a cooking chamber. A second heat source may be sized and configured to reheat, reburn, and/or recombust smoke generated within the cooking chamber. In an example embodiment, the first heat source may be a gas-powered heat source, such as one or more gas burners. Smoke may be generated by burning a solid fuel, such as pelletized fuel, and the smoke may be generated within the cooking chamber. The second heat source, which may be a gas-powered heat source, such as one or more gas burners, may reheat, reburn, and/or recombust the smoke. The second heat source may be smaller than the first heat source, and the second heat source may or may not be intended to cook foodstuffs in the cooking chamber. The second heat source may be part of the first heat source, or the second heat source may be at least partially independent of the first heat source. For example, the first heat source may be controlled by one or more sources, such as one or more knobs, and the second heat source may be controlled by one or more sources, such as one or more knobs. The knobs, for example, may control the flow of gas to the burners. The first heat source may be controlled to facilitate cooking operations and the second heat source may be controlled to facilitate the reheating, reburning, and/or recombusting of the smoke. Advantageously, the first and second heat sources may be controlled individually or in combination.

Another aspect is a cooking device that may include a cooking chamber; one or more cooking surfaces may be disposed in the cooking chamber, the cooking surfaces may be sized and configured for placement of foodstuffs; a first gas-powered heat source may include one or more burners disposed in the cooking chamber; a solid fuel heat source may include a drawer sized and configured to receive a solid fuel, the solid fuel heat source may be sized and configured to generate smoke, the drawer may be movable between a closed position in which the drawer and solid fuel are disposed inside the cooking chamber and an open position in which the drawer is at least partially removed from the cooking chamber; and a second gas-powered heat source may be sized and configured to reheat, reburn, and/or recombust the smoke from the solid fuel heat source. The cooking device may include a lid attached to the drawer, and the lid may include an opening sized and configured to allow the smoke from the solid fuel heat source to flow towards the second gas-powered heat source. The drawer may be inserted into an opening in the cooking chamber and the drawer may be removable from the cooking chamber. The drawer may extend along a first axis disposed between a rear portion of the cooking chamber and a front portion of the cooking chamber; the second gas-powered heat source may include a burner that extends along a second axis disposed between the rear portion of the cooking chamber and the front portion of the cooking chamber; the burner of the second gas-powered heat source may be at least partially disposed above the drawer; and the first axis and the second axis may be generally aligned and generally disposed in a parallel configuration. The drawer may hold all the solid fuel in the cooking chamber when the drawer is in the closed position. The smoke from the solid fuel heat source may have a first set of characteristics and the smoke from the second gas-powered heat source may have a second set of characteristics after the smoke from the solid fuel heat source is reheated, reburned, and/or recombusted, the first set of characteristics may be different from the second set of characteristics.

Still another aspect is cooking device that may include a cooking chamber; a gas-powered grill may include a plurality of gas burners disposed in the cooking chamber; a receptacle may be disposed in the cooking chamber, the receptacle may be sized and configured to receive pelletized fuel, the pelletized fuel may create a smoke during used of the cooking device; and a secondary gas burner may be disposed in the cooking chamber and may be at least partially disposed above the receptacle in a vertically stacked configuration, the secondary gas burner may be sized and configured to reheat, reburn, or recombust the smoke generated from the pelletized fuel. The secondary gas burner and the receptacle may be vertically disposed between a first gas burner and a second gas burner of the plurality of gas burners of the gas-powered grill. The receptacle may be a drawer that is slidably disposed in the cooking chamber. The drawer may include a divider that divides the drawer into an upper portion and a lower portion, the upper portion of the drawer may be sized and configured to receive the pelletized fuel, the lower portion of the drawer may be sized and configured to allow air to flow to the pelletized fuel. A lid may be attached to the receptacle, the lid may include an opening to allow the smoke to flow upwardly towards the secondary gas burner, the opening in the lid may be generally disposed below the secondary gas burner. An ignitor may be disposed in the cooking chamber, and the ignitor may be sized and configured to ignite the pelletized fuel in the receptacle. An air supply system may supply air to the receptacle, the air supply system may include a first end disposed in an outer wall of the cooking chamber and a second end disposed in the receptacle. The receptacle may have an elongated configuration that extends from a rear portion of the cooking chamber to a front portion of the cooking chamber; an ignitor may be disposed at least proximate a rear portion of the elongated receptacle, the ignitor may be sized and configured to ignite pelletized fuel in the rear portion of the receptacle; and a lid may be attached to the receptacle and the lid may include at least one opening that may be sized and configured to allow smoke from the burning, combusting, or smoldering of the pelletized fuel to flow towards the secondary gas burner. A grate may be disposed in the receptacle, and the pelletized fuel may be disposed on the grate.

Yet another aspect is a cooking device that may include a cooking chamber; a grill assembly may include one or more gas burners disposed in the cooking chamber; a smoke generation assembly may include a receptacle sized and configured to receive pelletized fuel, the smoke generation assembly may be sized and configured to generate smoke from the pelletized fuel; and a smoke reburning assembly may include a gas burner sized and configured to reheat, reburn, or recombust the smoke from the smoke generation assembly. A portion of the smoke generation assembly may be disposed below the smoke reburning assembly in a vertically stacked configuration. The smoke for the smoke generation assembly may have a first set of characteristics; the smoke from the smoke reburning assembly may have a second set of characteristics; and the first set of characteristics of the smoke from the smoke generation assembly may be different than the second set of characteristics of the smoke from the smoke reburning assembly. The smoke generation assembly and the smoke reburning assembly may be disposed below and between two of the gas burners of the one or more gas burners of the grill assembly. The receptacle may be a drawer that is slidably disposed in the cooking chamber; the drawer may extend between a rear portion of the cooking chamber and a front portion of the cooking chamber; an ignitor may be disposed towards a first end of the drawer, the ignitor may be sized and configured to ignite the pelletized fuel in the drawer; and the smoke generation assembly may be sized and configured to facilitate burning of the pelletized fuel from the first end of the drawer towards the second end of the drawer.

These and other aspects, features, and advantages will become more fully apparent from the following brief description of the drawings, the drawings, the detailed description of example embodiments, and appended claims.

### BRIEF DESCRIPTION OF THE DRAWINGS

The appended drawings contain figures of example embodiments to further illustrate and clarify the above and other aspects, advantages, and features of the present disclosure. It will be appreciated that these drawings depict only example embodiments and are not intended to limit its scope. Additionally, it will be appreciated that while the drawings may illustrate example sizes, scales, relationships, and configurations, the drawings are not intended to limit the scope of the claimed invention. The drawings may be to scale and representative of example embodiments, but the drawings are not necessarily to scale. The invention will be described and explained with additional specificity and detail using the accompanying drawings of example embodiments in which:

FIG. 1 is an upper front perspective view of an example cooking device;

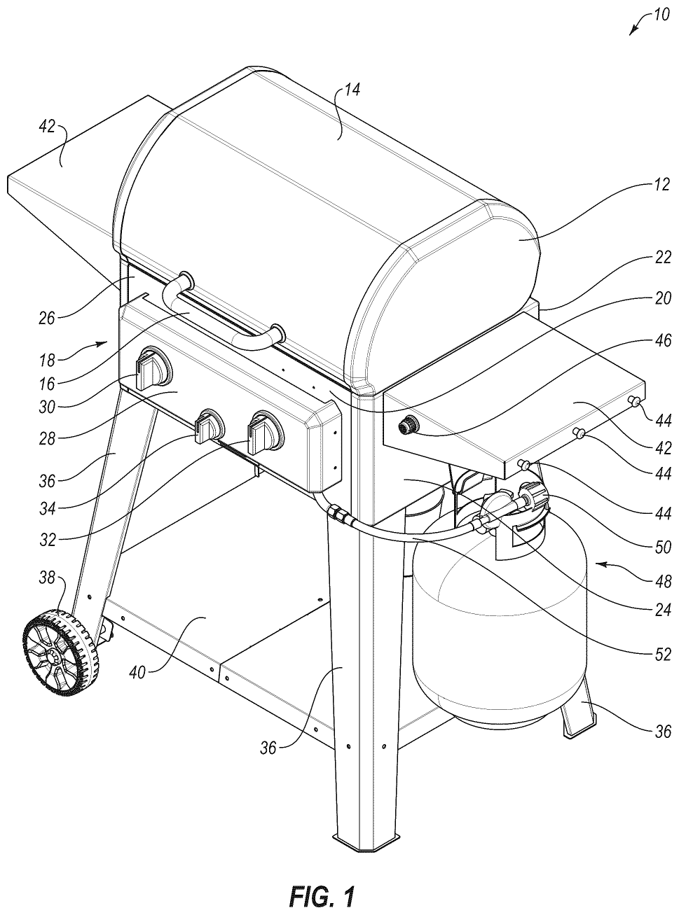

FIG. 2 is a lower rear perspective view of the example cooking device;

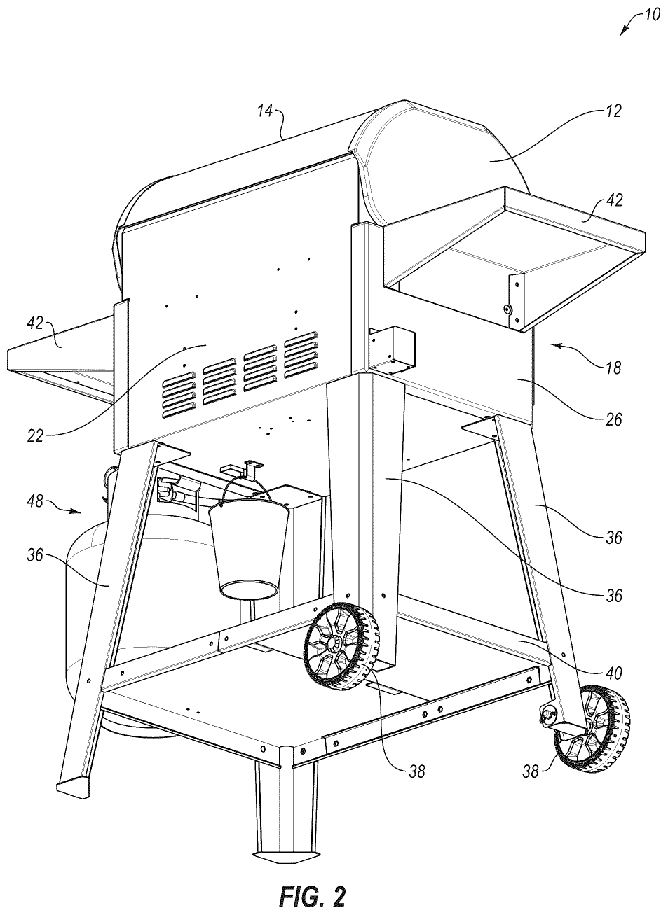

FIG. 3 is a lower front perspective view of the example cooking device;

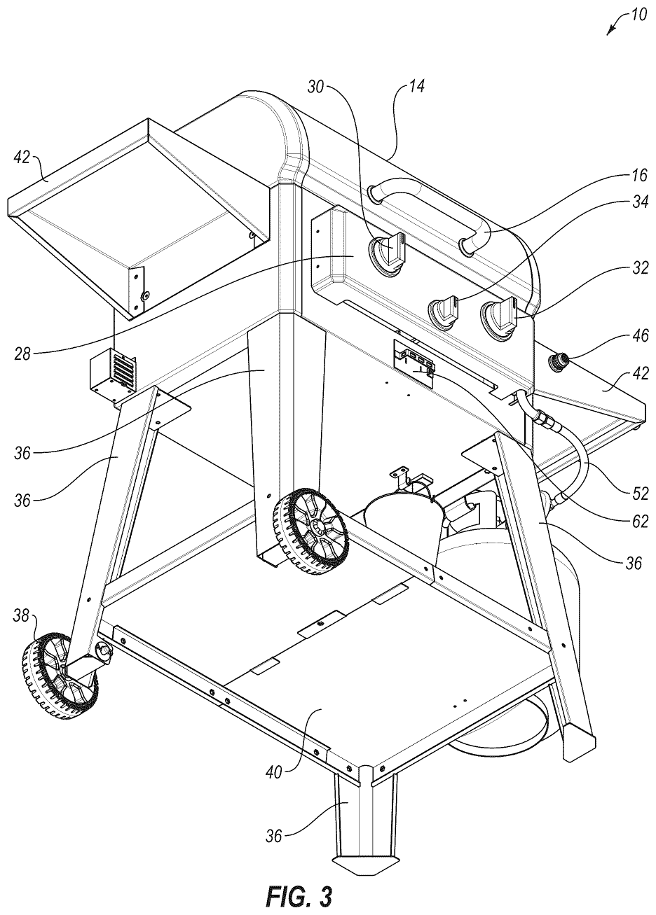

FIG. 4 is a lower front perspective view of the example cooking device, illustrating a drawer in an extended or open position;

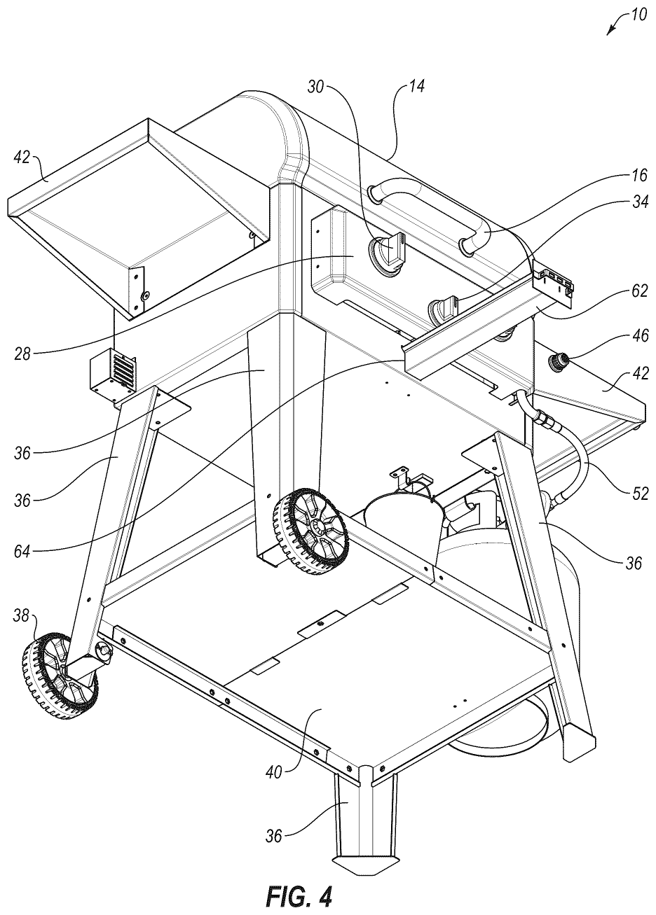

FIG. 5 is an upper front perspective view of the example cooking device, illustrating the drawer in the extended or open position;

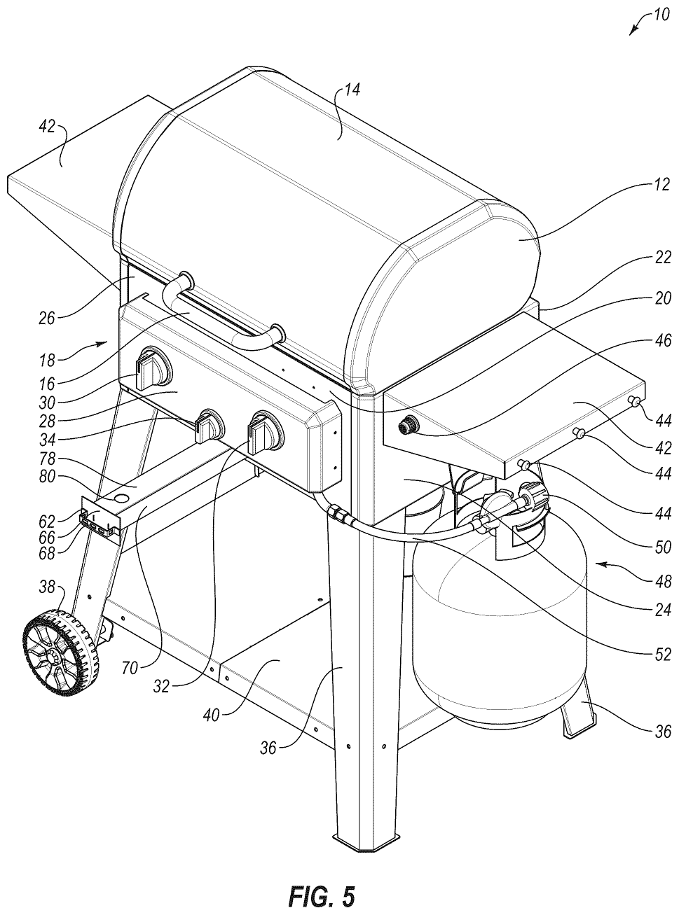

FIG. 6 is an enlarged view of a portion of the example cooking device, illustrating the drawer in the extended or open position;

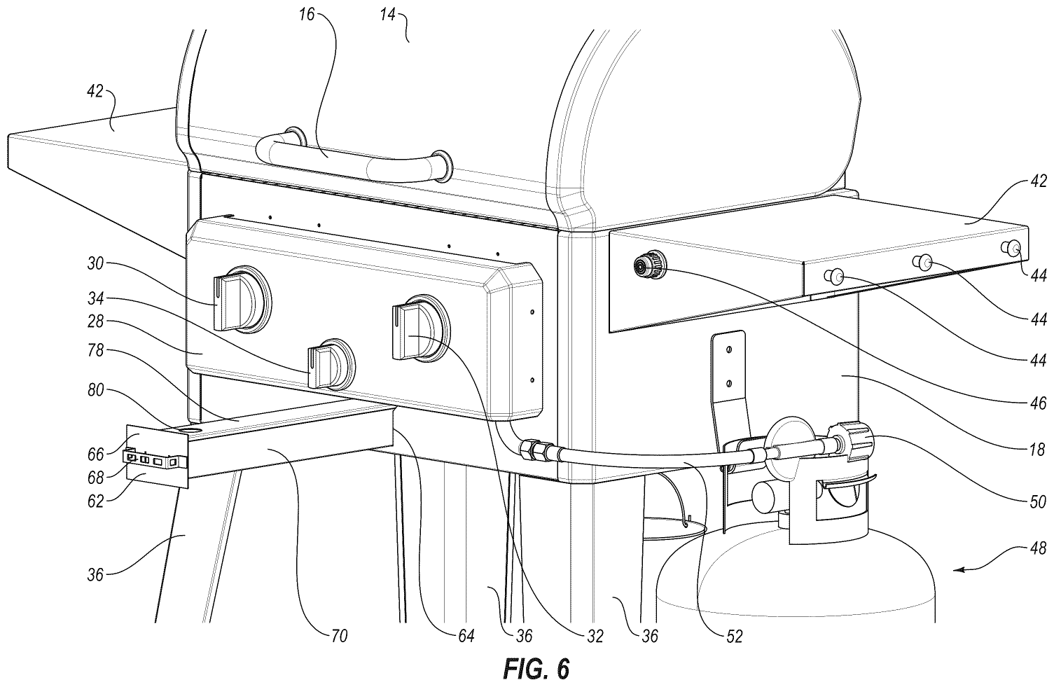

FIG. 7 is a cut-away side view of a portion of the example cooking device, illustrating the drawer in an inserted or closed position;

FIG. 8 is a cut-away side view of another portion of the example cooking device, illustrating the drawer in the extended or open position;

FIG. 9 is an upper front perspective view of an example drawer;

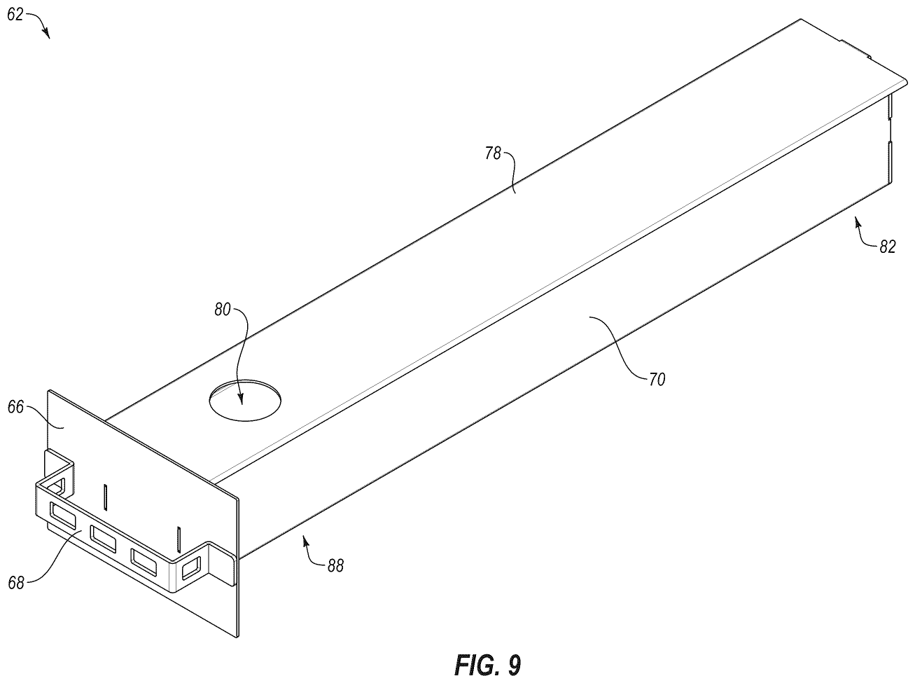

FIG. 10 is a lower rear perspective view of the example drawer;

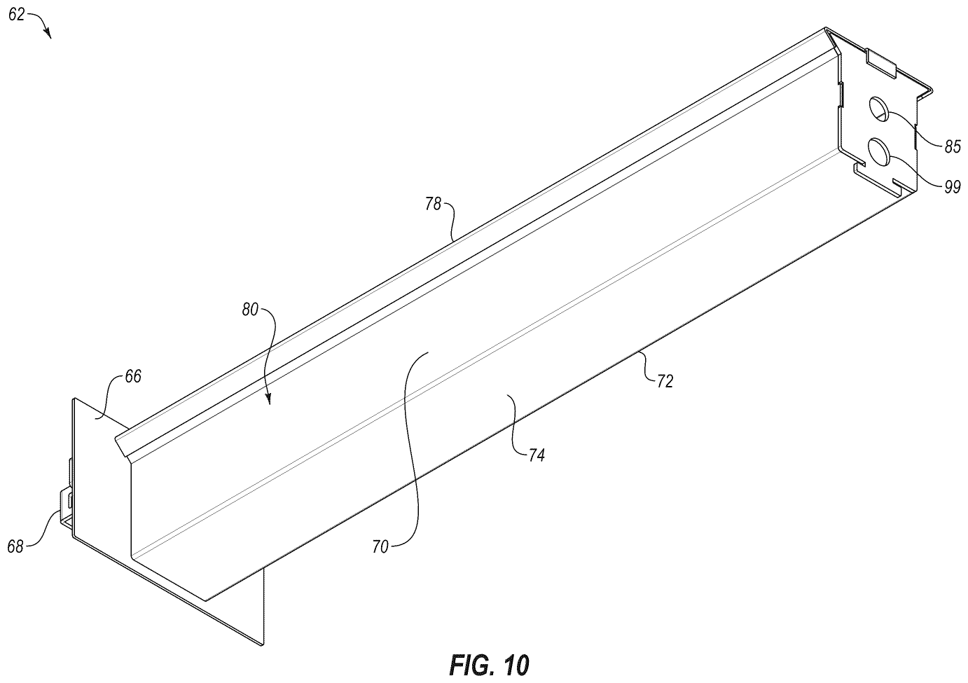

FIG. 11 is an upper front perspective view of the example drawer, illustrating the lid removed from the drawer; and

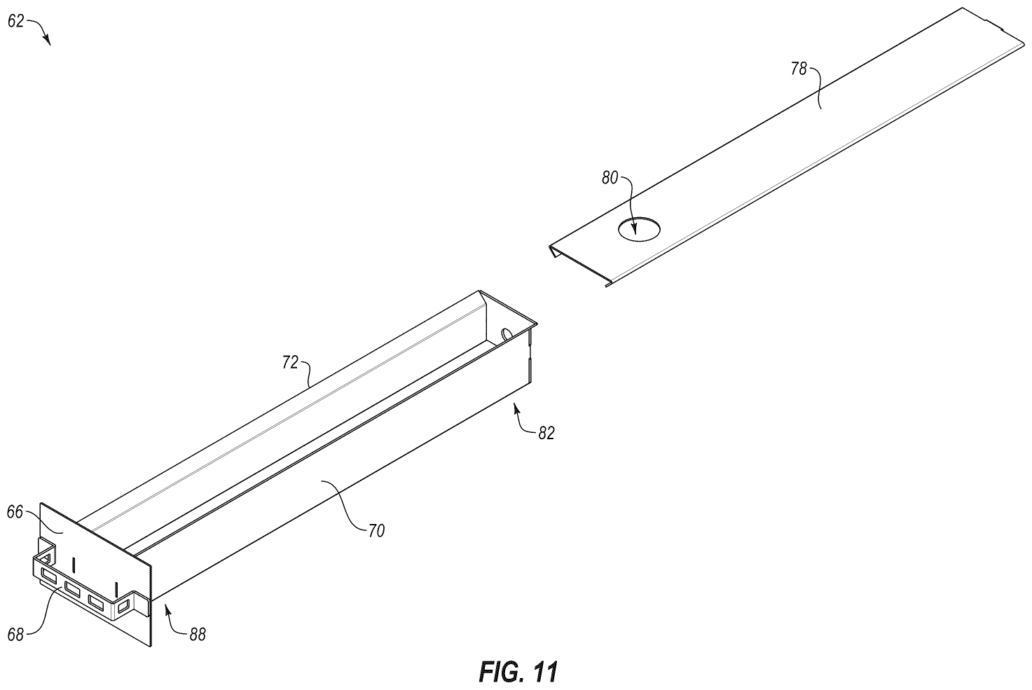

FIG. 12 is an upper rear perspective view of the example drawer, illustrating the lid removed from the drawer.

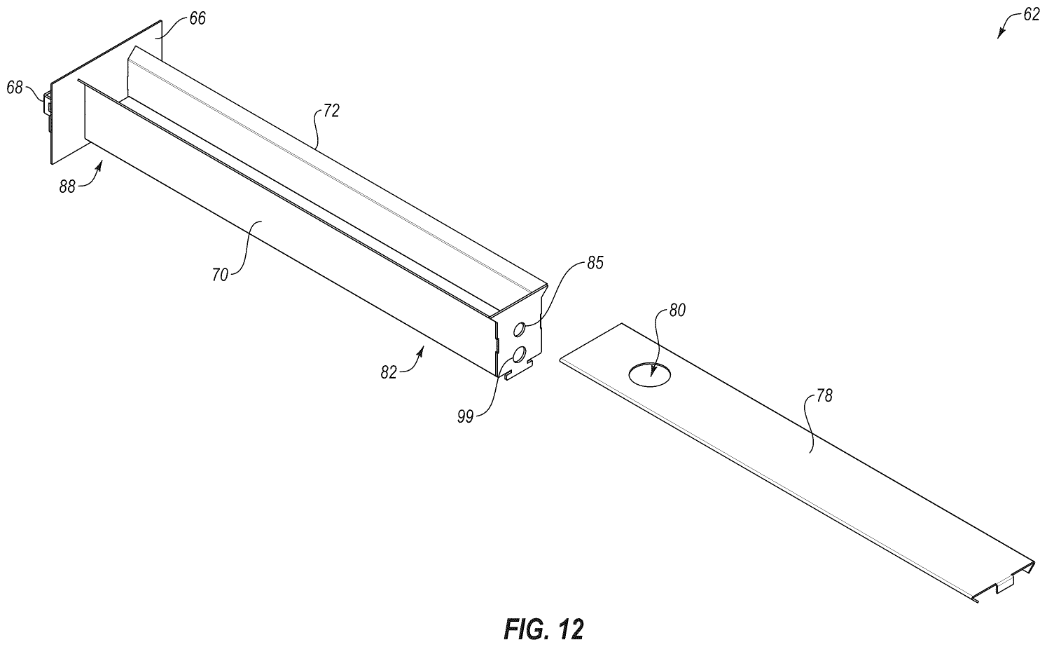

### DETAILED DESCRIPTION

This disclosure is generally directed towards cooking devices, and systems, apparatuses, and methods for preparing, warming, and/or cooking foodstuffs, such as grilling and/or smoking, and adding taste, flavoring, and/or seasoning to foodstuffs, such as a smoky taste, flavoring, and/or seasoning to foodstuffs. Advantageously, the cooking device may prepare, warm, and/or cook foodstuffs by grilling, and the cooking device may add a smoky taste, flavoring, and/or seasoning to foodstuffs. The principles of the present invention, however, are not limited to cooking devices. It will be understood that, in light of the present disclosure, the cooking device can be used in connection with other types of cooking, heating, structures, and the like.

Additionally, to assist in the description of the cooking device, words such as top, bottom, front, rear, right, and left may be used to describe the accompanying figures. It will be appreciated that the cooking device, and parts and components of the cooking device, can be disposed in a variety of desired positions, including various angles, sideways, and even upside down.

It will also be appreciated that the singular forms “a,” “an,” and “the” may include plural forms as well, depending, for example, upon context. It will also be appreciated that the terms “comprises,” “comprising,” “including,” and “having” may be inclusive and may specify the presence of stated features, steps, operations, elements, and/or components, but do not preclude the presence or addition of one or more other features, steps, operations, elements, components, and/or groups thereof. In addition, the wording “and/or” can include any and all combinations of one or more of the associated and/or listed items.

Spatially relative terms, such as “inner,” “outer,” “beneath,” “below,” “lower,” “above,” “upper,” and the like, may be used for ease of description to describe one or more elements, and/or a relationship to another element(s) or feature(s). Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features depending, for example, upon context. Thus, the example term “below” can encompass both an orientation of above and below. The device may be otherwise oriented (e.g., rotated 90 degrees or at other orientations) and the spatially relative descriptors may be interpreted accordingly. It will be understood that phrases such as “between X and Y” may be interpreted to include X and Y. And phrases such as “from X to Y” may be interpreted to include X and Y.

It will also be understood that wording such as “on,” “attached,” “connected,” etc. may indicate one or more elements are directly on, attached, or connected, and/or one or more intervening elements may also be present. In contrast, when an element is referred to as being, for example, “directly attached to” another element, no intervening elements may be present. It will further be understood that references to a structure or feature that is disposed “adjacent” to another structure or feature may or may not not have portions that touch, overlap, or underlie the adjacent feature.

In addition, it will be understood that terms such as “first,” “second,” etc. may be used to describe various elements, but these elements should not necessarily be limited by these terms. For example, these terms may be used to distinguish one element from another. Thus, a “first” element could also be termed a “second” element without departing from the teachings of the present disclosure. Accordingly, terms such as “first” and “second” may be used for convenience and readability, but these terms may not identify specific elements or features. Additionally, a sequence or process, such as one or more steps, may not be limited to the specific order listed depending upon context. Further, the disclosure may include any number of features, aspects, advantages, and the like, in any combination, and one or more of the features, aspects, advantages, and the like may not be present, needed, or required, The present disclosure could also include one or more additional features, aspects, advantages, and the like depending, for example, upon the intended use of the cooking device.

The drawings may be diagrammatic, schematic, and other representations of example embodiments, and may not be intended to limit the present disclosure. Moreover, while various drawings may be provided to scale, and in example arrangements and/or configurations, the drawings are not necessarily drawn to scale and the various embodiments may have other suitable shapes, sizes, arrangements, and/or configurations. Thus, the proportionality, scale, size, shape, form, function, arrangement, configuration, and/or other features of the disclosed embodiments may be as shown in the drawings or may be altered without necessarily departing from the scope of this disclosure.

In the example embodiments illustrated in the accompanying figures, like structures may be provided with similar reference designations for convenience and readability. It will be understood that no limitation of the scope of the disclosure may be intended. It will also be understood that the language used to describe the example embodiments is illustrative only and is not to be construed as limiting the scope of the disclosure.

As seen in the accompanying figures, an example cooking device may include multiple heat sources, such as a first heat source, a second heat source, and a third heat source. One or more of the heat sources may be disposed in a stacked configuration. For example, the second heat source and the third heat source may be at least partially disposed in a vertically stacked configuration.

As shown in the accompanying figures, a cooking device 10 may include a cooking chamber 12. A lid 14 may provide access to the cooking chamber 12, and the lid 14 may include a handle 16. The lid 14 may be opened and closed, and the lid 14 may provide access to the cooking chamber 12. The lid 14 may be pivotally attached, and the lid 14 may form a portion of the cooking chamber 12. For example, when the lid 14 is closed, the lid 14 may form an upper portion of the cooking chamber 12. It will be appreciated that the lid 14 may be disposed in the open position in some cooking operations. The lid 14 may facilitate placement and/or removal of foodstuffs from the cooking chamber 12.

The cooking device 10 may include a body portion 18, and the body portion 18 may include a front portion 20, a rear portion 22, a right side 24, and a left side 26. A control panel 28 may be disposed on the front portion 20 of the body portion 18, and the control panel 28 may include one or more controls such as a first control 30, a second control 32, and a third control 34. The controls 30, 32, 34 may be knobs, rotatable members, switches, and the like. The controls 30, 32, 34 may be manually controlled and/or automatically controlled. While the example cooking device 10 is shown and described as having three controls 30, 32, 34, it will be understood that the cooking device may have any suitable number of controls and the controls may be disposed in other locations, configurations, and/or arrangements depending, for example, upon the intended use of the cooking device 10.

The cooking device 10 may be supported by one or more supports, such as support legs 36, and the cooking device may include one or more wheels 38, which may facilitate movement of the cooking device 10. The cooking device 10 may include a base 40, which may be connected to the legs 36, and one or more shelves 42. For example, a shelf 42 may be disposed on the right side 24 of the body portion 18 and another shelf 42 may be disposed on the left side 26 of the body portion 18. The shelves 42 may be pivotably or rotatably attached, and/or the shelves 42 may be removably or permanently attached. The shelves 42 shown in the accompanying figures extend outwardly from the body portion 18 of the cooking device 10 and the shelves 18 may provide surfaces that facilitate use of the cooking device. The shelves 42 may include one or more attachment portions 44, such as hooks, hangers, catches, projections, and the like, which may be sized and configured to hold items such spatulas, tongs, brushes, and the like. The cooking device 10 may also include one or more controls, such as a buttons or switches, which may be used to start the cooking device 10. In an example embodiment, the cooking device 10 may include a start button 46 that may be engaged to start the cooking device 10.

The cooking device 10 may include a fuel system 48 and the fuel system 48 may supply fuel to the cooking device 10. In an example embodiment, the fuel system 48 may provide a combustible gas to the cooking device. The fuel system 48 may include a fuel source or container, such as a tank or cylinder, and the tank may be sized and configured to hold a gas, such as propane or natural gas. The fuel system 48 may include a controller 50, which may control flow of gas from the tank, and the fuel system 48 may include a line 52 that supplies fuel to the cooking device 10.

The fuel system 48 may supply fuel to one or more gas burners disposed in the cooking chamber 12. For example, the cooking device 10 may include a first gas burner 54 and a second gas burner 56, and the gas burners may be disposed in the cooking chamber 12. The first gas burner 54 may be controlled by the first control knob 30, and the second gas burner 56 may be controlled by the second control knob 32. The first and second gas burners 54, 56 may be part of a heat source 58, which may be referred to as a first heat source for convenience and readability. The first heat source 58 may be part of a gas-powered grill.

The cooking device 10 may include another heat source 60 and this heat source 60 may be sized and configured to burn or combust a solid fuel, such as pelletized fuel. This heat source 60 may be referred to as a second heat source and/or a solid fuel system because it may burn or combust solid fuels such as pellets or wood pellets (even if the pellets do not contain wood). The solid fuel system 60 may include a vessel or receptacle, such as a drawer 62, and the drawer 62 may be sized and configured to receive pelletized fuel. The drawer 62 may be removably disposed in the cooking chamber 12. For example, the drawer 62 may be inserted and removed through an opening 64 in the front portion 20 of the body portion 18 of the cooking device. The opening 64 may be disposed below the control panel 28, and the drawer 62 may be at least partially or fully removed from the cooking chamber 12. The removable drawer 62 may facilitate filling the drawer with pellets, emptying unused pellets from the drawer, cleaning the drawer, using different types of pellets, using other kinds or types of combustible materials, and the like. The drawer 62, however, does not have to be removable and the drawer 62 could be disposed in a fixed position.

As shown in the accompanying figures, the drawer 62 may include a front portion, such as a front panel 66, a handle 68, a right side 70, a left side 72, a lower portion 74, and an upper portion 76. A lid 78 may be disposed proximate the upper portion 76 of the drawer 62 and the lid 78 may be attached to the drawer 62. For example, the lid 78 may be slidably attached to the drawer 62. The lid 78 may include one or more openings 80, and the openings 80 may be disposed proximate the front panel 66 of the drawer 62 when the lid 78 is attached to the drawer 62.

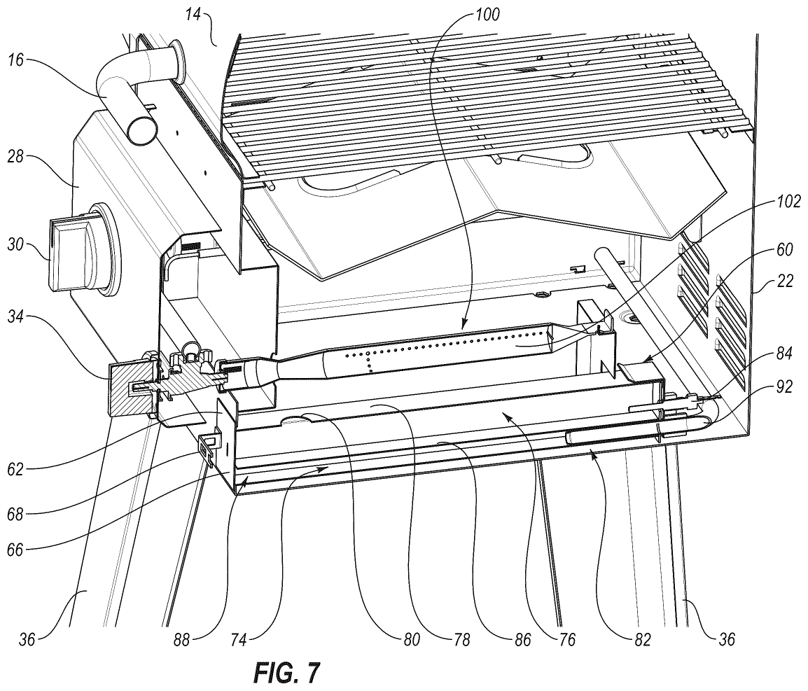

As shown in FIG. 7, when the drawer 62 is disposed in the cooking device 10, a rear portion 82 of the drawer 62 may be disposed towards the rear portion 22 of the body portion 18. An ignition source 84, such as an ignitor, may be at least partially disposed in an opening 85 in the rear portion 82 of the drawer 62. The ignitor 84 may be sized and configured to ignite solid fuel, such as pelletized fuel, disposed in the drawer 62. Once ignited, thermal energy generated by the combustion of the pelletized fuel may be sufficient to ignite and combust adjacent pelletized fuel. In this example configuration, the ignitor 84 may be sized and configured to ignite pelletized fuel disposed in the rear portion 82 of the drawer 62. If the pelletized fuel is ignited in the rear portion 82 of the drawer 62, that may allow the fuel to burn from the rear portion 82 of the drawer 62 towards a front portion 88 of the drawer 62.

The drawer 62 may include a divider 86, and the divider 86 may divide at least a portion of the drawer 62. For example, as shown in FIG. 7, the divider 86 may horizontally divide the drawer 62 between the lower portion 74 and the upper portion 76. The divider 86 may include one or more openings or apertures, and the divider 86 may be a grate or screen. The upper portion 76 of the drawer 62 may be sized and configured to receive pelletized fuel, and the divider 86 may prevent the pelletized fuel from entering the lower portion 74 of the drawer 62. The divider 86 may be sized and configured to allow air to flow between the lower and upper portions 74, 76 of the drawer 62. In an example embodiment, the divider 86 may allow air to flow from the lower portion 74 of the drawer 62 towards the upper portion 76 of the drawer 62.

The cooking device 10 may include an air supply system 92 and the air supply system 92 may facilitate the flow of air within the cooking device 10. For example, the air supply system 92 may facilitate the flow of air to the solid fuel system 60. The air supply system 92 may include a conduit 94 that allows air to flow to the lower portion 74 of the drawer 62. The conduit 94 may include an end 96 that allows air from outside the cooking device 10 to enter the conduit 94. For example, the end 96 may be disposed in an opening in the left side 26 of the body portion 18 and that may allow air to enter the conduit 94. The conduit 94 may include another end 98 that may supply air to a portion of the solid fuel system 60, such as the lower portion 74 of the drawer 62. The air supply system 92 may include a fan or other device to facilitate movement of the air. For example, a fan may be used to blow air into the lower portion 74 of the drawer 62. Advantageously, the air supply system 92 may supply a desired amount of air to the solid fuel system 60, which may facilitate burning or combustion of the solid fuel. The air supply system 92 may also be sized and configured to facilitate generation of smoke. For example, the air supply system 92 may supply a limited amount of air to the solid fuel system, which may facilitate the creation of smoke.

The air supply system 92 may create an air flow that assists in the combustion of the solid fuel, and the solid fuel may burn in a desired pattern or arrangement. For example, the air may flow from the rear portion 82 towards the front portion 88 of the drawer 62, which may encourage combustion of the solid fuel from the rear portion 82 to the front portion 88 of the drawer 62. In addition, because the ignitor 84 may be disposed in the rear portion 82 of the drawer 62, the solid fuel may be ignited in the rear portion 82 of the drawer 62 and that may assist in combustion of the fuel from the rear towards the front of the drawer 62.

In greater detail, the air supply system 92 may provide air to the lower portion 74 of the drawer 62 and pelletized fuel may be disposed in the upper portion 76 of the drawer 62. The ignitor 84 may ignite pelletized fuel disposed towards the rear portion 82 of the drawer 62 and the air may traverse the divider 86 from the lower portion 74 to the upper portion 76 of the drawer 62. The air supply system 92 may help control the rate and amount of air flowing towards the pelletized fuel, which may help control the rate at which the fuel is burned. The air flowing towards the pelletized fuel may also help control the creation of smoke. For example, the air flow may facilitate smoldering and/or slow burning of the fuel, which may increase smoke generation.

The smoke generated by the burning, smoldering, and/or combustion of the pelletized fuel may flow primarily out of the opening 80 in the front portion of the lid 78. Thus, the smoke generated by the solid fuel system 60, also referred to as the second heat source, may primarily flow upwardly through the opening 80.

The cooking device 10 may include a heat source 100 and the heat source 100 may be disposed in the cooking chamber 12. In an example embodiment, the heat source 100 may be a gas burner 102. For convenience and readability, the heat source 100 may be referred to as a third heat source and/or a second gas heat source. It will be understood that the cooking device 10 may include any suitable number and type of heat sources, and the heat sources may have other shapes, sizes, configurations, and/or arrangements depending, for example, upon the intended use of the cooking device 10.

The heat source 100 may be at least partially disposed above the solid fuel system 60. For example, the burner 102 may be generally horizontally aligned with the drawer 62, and the burner 102 may be disposed above the drawer 62 in a generally parallel configuration. In an example embodiment, the burner 102 may be disposed above the drawer 62 in a vertically stacked configuration. The burner 102 may be a gas-powered burner that uses the same fuel system 48 as the first and second gas burners 54, 56. The burners 54, 56, and/or 102 may also be independent and/or interconnected in any desired manner.

The burner 102 may be controlled by the controller 34, such as the third controller. The controller 34 may have a different size, shape, configuration, and/or arrangement to help distinguish the controller 34 from the controllers 30, 32. For example, the controller 34 may be smaller than the controllers 30, 32 because the burner 102 may be smaller than the first and/or second burners 54, 56. In this example embodiment, the burner 102 may be sized and configured to reheat, reburn, and/or recombust smoke generated by the solid fuel system 60. Thus, smoke may primarily flow from the opening 80 in the lid 78 towards the burner 102, and the burner 102 may reheat, reburn, and/or recombust the smoke. The reheating, reburning, and/or recombusting the smoke may improve the flavoring, taste, and/or seasoning of the foodstuffs. It will be appreciated that the smoke does not have to be reheated, reburned, and/or recombusted. For example, smoke flavoring, taste, and/or seasoning may be created by using the solid fuel system 60 without the third heat source 100. Additionally, or alternatively, smoke flavoring, taste, and/or seasoning may be created by using the solid fuel system 60 and the third heat source 100. It will be appreciated that use of the solid fuel system 60 and/or the third heat source 100 is not required. Thus, the cooking device 10 may be used with or without the solid fuel system 60 and/or the third heat source 100, and the solid fuel system 60 and the third heat source 100 may be used in combination and/or independently depending, for example, upon the intended use of the cooking system 10.

The second and third heat sources 60, 100 may increase the functionality and potential uses of the cooking device 10. For example, the second and/or third heat sources 60, 100 may provide a small amount of heat to the cooking chamber 12, such as to warm or maintain food at a relatively temperature such as between about 150° and about 200°. The second and third heat sources 60, 100 may also create different types of smoke or smoke with different characteristics depending, for example, if the smoke is reheated, reburned, and/or recombusted. The second and third heat sources 60, 100 may also be simultaneously and/or independently used with or without the first heat source 58, which may increase the potential uses of the cooking device 10. This may allow, in an example embodiment, the cooking device 10 to be used as a grill by using the first heat source 58 without the second or third heat sources 60, 100. Additionally, or alternatively, the cooking device 10 may be used as a grill by using the first heat source 58 and with smoke flavoring, taste, or seasoning by using the second heat source 60. Additionally, or alternatively, the cooking device 10 may be used as a grill by using the first heat source 58 with smoke flavoring, taste, or seasoning having different characteristics by using the second heat source 60 and the third heat source 100. Additionally, or alternatively, the second heat source 60 may be used to add smoke flavoring, taste, or seasoning without using the first or third 50, 100 heat source. Additionally, or alternatively, the second heat source 60 and the third heat source 100 may be used in combination to add smoke flavoring, taste, or seasoning with different characteristics. Additionally, or alternatively, the third heat source 100 may be used to cook or heat foodstuffs without using the first or second heat sources 58, 60. Thus, the heat sources may provide different functionality and uses. For example, the first heat source 58 may be a gas-powered grill that may be used for cooking processes such as grilling, barbequing, chargrilling, and other types of warming, preparing, and/or cooking foodstuffs. The second heat source 60 may generate smoke, and the smoke may be used to flavor and/or change the taste of the foodstuffs. The second heat source 60 may use heat to generate smoke and/or may give off heat while generating smoke. The third heat source 100 may be used to reheat, reburn, and/or recombust smoke, such as the smoke from the second heat source 60. After reviewing this disclosure, one skilled in the art will appreciate that the cooking device 10 may have multiple different uses and one or more features may be used concurrently and/or independently, which may increase the functionality of the cooking device 10.

Advantageously, the cooking device 10 may include one or more heat sources, such as the heat sources 58, 60, 100, and the heat sources may be different types and/or may be used for different purposes. For example, the first heat source 58 and the second heat source 60 may be different types and/or may be used for different purposes. The second heat source 60 and the third heat source 100 may be different types and/or may be used for different purposes. In an example embodiment, the first and third heat sources 58, 100 may be the same or similar types of heat sources, e.g., gas-powered burners, and the burners may be used to heat the cooking chamber. The first and third heat sources 58, 100, however, may be used for different purposes. For instance, the first heat source 58 may be primarily used to heat and/or cook foodstuffs in the cooking chamber 12, while the third heat source 100 may be primarily used to reheat, reburn, and/or recombust smoke. The second heat source 60 may use a different type of fuel, such as a solid fuel source, than the first or third heat sources 58, 100. The second heat source 60 may also have a different purpose, such as smoke generation. Thus, in an example embodiment, the first heat source 58 may generate or emit a relatively large amount of heat or thermal energy, which may facilitate cooking. The second heat source 60 may be sized and configured to generate smoke, and the smoke may be used to flavor, season, and/or change the taste of the foodstuffs. The third heat source 100 may reheat, reburn, and/or recombust the smoke, which may create smoke with different characteristics, which may provide different flavoring, taste, and/or seasoning to foodstuffs.

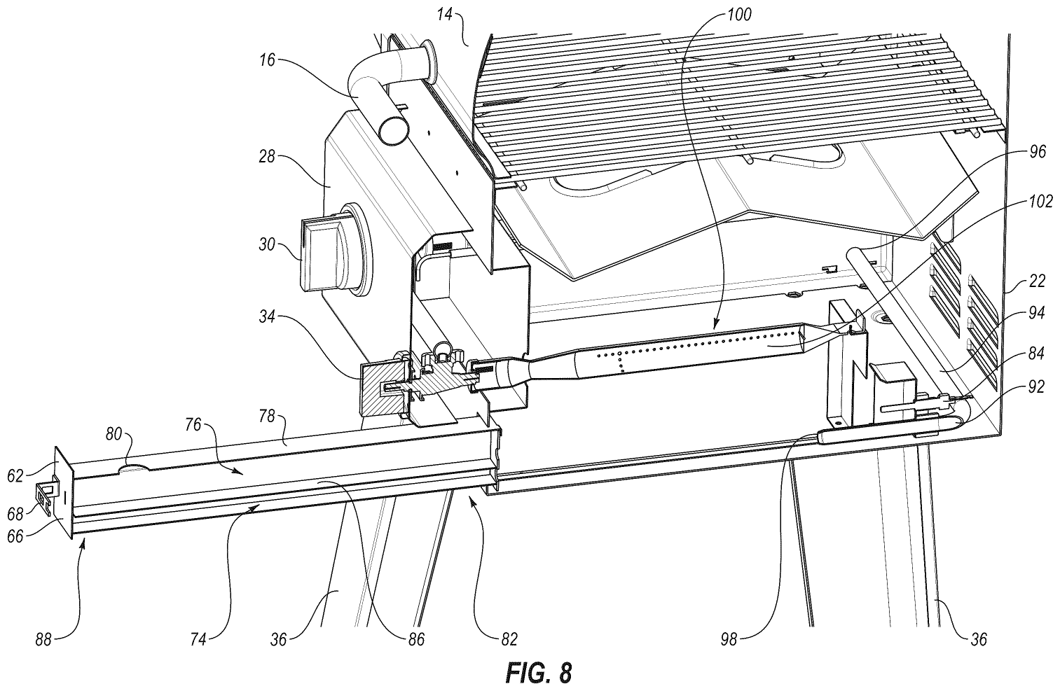

As shown in FIGS. 7 and 8, the drawer 62 may be removably disposed below the burner 102 in a vertically stacked configuration, and the drawer 62 and/or the burner 102 may generally be aligned and disposed between the front portion 20 and the rear portion 22 of the cooking device 10 during use. The drawer 62 and/or the burner 102 may be generally centrally disposed in the cooking chamber 12, and the drawer 62 and/or the burner 102 may be generally disposed between the first burner 54 and the second burner 56. After reviewing this disclosure, one skilled in the art will appreciate that the heat sources, and various components of the heat sources, may have different shapes, sizes, configurations, and/or arrangements depending, for example, upon the intended use of the cooking device 10.

The cooking device 10, as shown in FIGS. 7 and 8, may include one or more cooking surfaces or structures 104 configured for placement of foodstuffs. The cooking surfaces 104 may have a grill-like configuration and the cooking surfaces 104 may be in the form of a metal grid, lattice, or framework. The cooking surfaces 104 may have other configurations, such as solid surfaces or surfaces with one or more openings. The cooking surfaces 104 may be removable, which may facilitate cleaning. The cooking surfaces 104 may be constructed from thermally conductive materials, such as metal or ceramic.

The cooking device 10 may include other components, features, aspects, and the like. For example, the cooking device 10 may include one or more electronic components, electronic controls, displays, information systems, etc., which may facilitate control over one or more portions or systems of the cooking device 10. For instance, the cooking device 10 may include one or more components, features, aspects, and the like that control temperature of the cooking chamber 12. The control device 10 may also include one or more inputs, displays, controls, etc. that may measure temperature of the foodstuffs, allow remote operation of the cooking device, and the like.

In operation of an example embodiment of the cooking device 10, the first heat source 58 may be used for warming, cooking, and/or preparing foodstuffs at a relatively high temperature (e.g., greater than about 350 degrees fahrenheit). If smoke flavoring, taste, and/or seasoning is desired, the drawer 62 may be filled with pelletized fuel and the drawer may be disposed within the cooking chamber 12. The ignitor 84, which may be controlled by the start button 46. may ignite or cause one or more pellets to begin burning, combusting, and/or smoldering. Airflow to the pellets may be at least partially controlled by the air supply system 92, and the air supply system 92 may at least partially control the amount of smoke generated by the burning, combustion, and/or smoldering of the pellets. If smoke with different types of characteristics is desired, the third heat source 100 may be used to reheat, reburn, and/or recombust the smoke.

The first heat source 58, the second heat source 60, and the third heat source 100 may be operated independently, concurrently, and/or individually. In addition, the first heat source 58, the second heat source 60, and the third heat source 100 may be usable in some combination.

After reviewing this disclosure, one skilled in the art will understand the cooking device 10 may have other suitable shapes, sizes, configuration, and/or arrangements. The cooking device 10 may also include any suitable number of components depending, for example, upon the size and configuration of the cooking device.

After reviewing this disclosure, one skilled in the art will understand that modifications, additions, or omissions may be made to the cooking device 10 without departing from the scope of the present disclosure. Moreover, the separation of various components in the embodiments described herein is not meant to indicate that the separation occurs in all embodiments and the various components may be separated by different distances, if desired. Moreover, one skilled in the art will understand with the benefit of this disclosure that one or more of the components may be integrated together in a single component or separated into multiple components. While the cooking device 10 may include one or more components, it will be appreciated after reviewing this disclosure that one or more of these components may not be required, and other suitable components, features, and the like may be used in connection with the cooking device 10. For example, the cooking device 10 may include one or more components, features, aspects, and the like such as described in U.S. Pat. Nos. 10,292,531; 10,495,317; and 10,806,301; each of which is incorporated by reference in its entirety.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A cooking device, comprising:
a cooking chamber;
one or more cooking surfaces disposed in the cooking chamber, the cooking surfaces sized and configured for placement of foodstuffs;
a first gas-powered heat source including one or more burners disposed in the cooking chamber;
a solid fuel heat source including a drawer sized and configured to receive a solid fuel, the solid fuel heat source sized and configured to generate smoke, the drawer movable between a closed position in which the drawer and solid fuel are disposed inside the cooking chamber and an open position in which the drawer is at least partially removed from the cooking chamber; and
a second gas-powered heat source that is sized and configured to reheat, reburn, and/or recombust the smoke from the solid fuel heat source.

2. The cooking device of claim 1, further comprising a lid attached to the drawer, the lid including an opening sized and configured to allow the smoke from the solid fuel heat source to flow towards the second gas-powered heat source.

3. The cooking device of claim 1, wherein the drawer is inserted into an opening in the cooking chamber and the drawer is removable from the cooking chamber.

4. The cooking device of claim 1, wherein the drawer extends along a first axis disposed between a rear portion of the cooking chamber and a front portion of the cooking chamber;
wherein the second gas-powered heat source includes a burner that extends along a second axis disposed between the rear portion of the cooking chamber and the front portion of the cooking chamber;
wherein the burner of the second gas-powered heat source is at least partially disposed above the drawer; and
wherein the first axis and the second axis are generally aligned and generally disposed in a parallel configuration.

5. The cooking device of claim 1, wherein the drawer holds all the solid fuel in the cooking chamber when the drawer is in the closed position.

6. The cooking device of claim 1, wherein the smoke from the solid fuel heat source has a first set of characteristics and the smoke from the second gas-powered heat source has a second set of characteristics after the smoke from the solid fuel heat source is reheated, reburned, and/or recombusted, the first set of characteristics being different from the second set of characteristics.

7. A cooking device comprising:
a cooking chamber;
a gas-powered grill including a plurality of gas burners disposed in the cooking chamber;
a receptacle disposed in the cooking chamber, the receptacle sized and configured to receive pelletized fuel, the pelletized fuel creating a smoke during used of the cooking device; and
a secondary gas burner disposed in the cooking chamber and at least partially disposed above the receptacle in a vertically stacked configuration, the secondary gas burner sized and configured to reheat, reburn, or recombust the smoke generated from the pelletized fuel.

8. The cooking device of claim 7, wherein the secondary gas burner and the receptacle are vertically disposed between a first gas burner and a second gas burner of the plurality of gas burners of the gas-powered grill.

9. The cooking device of claim 7, wherein the receptacle is a drawer that is slidably disposed in the cooking chamber.

10. The cooking device of claim 9, wherein the drawer includes a divider that divides the drawer into an upper portion and a lower portion, the upper portion of the drawer sized and configured to receive the pelletized fuel, the lower portion of the drawer sized and configured to allow air to flow to the pelletized fuel.

11. The cooking device of claim 7, further comprising a lid attached to the receptacle, the lid including an opening to allow the smoke to flow upwardly towards the secondary gas burner, the opening in the lid generally disposed below the secondary gas burner.

12. The cooking device of claim 7, further comprising an ignitor disposed in the cooking chamber, the ignitor sized and configured to ignite the pelletized fuel in the receptacle.

13. The cooking device of claim 7, further comprising an air supply system that supplies air to the receptacle, the air supply system including a first end disposed in an outer wall of the cooking chamber and a second end disposed in the receptacle.

14. The cooking device of claim 7, wherein the receptacle has an elongated configuration that extends from a rear portion of the cooking chamber to a front portion of the cooking chamber;
wherein an ignitor is disposed at least proximate a rear portion of the elongated receptacle, the ignitor being sized and configured to ignite pelletized fuel in the rear portion of the receptacle; and
wherein a lid is attached to the receptacle and the lid includes at least one opening that is sized and configured to allow smoke from the burning, combusting, or smoldering of the pelletized fuel to flow towards the secondary gas burner.

15. The cooking device of claim 7, further comprising a grate disposed in the receptacle, the pelletized fuel being disposed on the grate.

16. A cooking device, comprising:
a cooking chamber;
a grill assembly including one or more gas burners disposed in the cooking chamber;
a smoke generation assembly including a receptacle sized and configured to receive pelletized fuel, the smoke generation assembly sized and configured to generate smoke from the pelletized fuel; and
a smoke reburning assembly including a gas burner sized and configured to reheat, reburn, or recombust the smoke from the smoke generation assembly.

17. The cooking device of claim 16, wherein a portion of the smoke generation assembly is disposed below the smoke reburning assembly in a vertically stacked configuration.

18. The cooking device of claim 16, wherein the smoke for the smoke generation assembly has a first set of characteristics;
wherein the smoke from the smoke reburning assembly has a second set of characteristics; and
wherein the first set of characteristics of the smoke from the smoke generation assembly is different than the second set of characteristics of the smoke from the smoke reburning assembly.

19. The cooking device of claim 16, wherein the smoke generation assembly and the smoke reburning assembly are disposed below and between two of the gas burners of the one or more gas burners of the grill assembly.

20. The cooking device of claim 16, wherein the receptacle is a drawer that is slidably disposed in the cooking chamber;
wherein the drawer extends between a rear portion of the cooking chamber and a front portion of the cooking chamber;
wherein an ignitor is disposed towards a first end of the drawer, the ignitor being sized and configured to ignite the pelletized fuel in the drawer; and
wherein the smoke generation assembly is sized and configured to facilitate burning of the pelletized fuel from the first end of the drawer towards a second end of the drawer.
